(19) United States
(12) Patent Application Publication
(10) Pub. No.: US 2007/0097166 A1
(43) Pub. Date: May 3, 2007

(54) Position detector and liquid ejecting apparatus incorporating the same

(75) Inventors: Satoshi Nakata, Tokyo (JP); Hitoshi Igarashi, Tokyo (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/546,697

(22) Filed: Oct. 11, 2006

(30) Foreign Application Priority Data
Oct. 11, 2005 (JP) P2005-295967

(51) Int. Cl. B41J 29/393

(52) U.S. Cl. 347/19

(57) ABSTRACT

A liquid ejecting head is operable to eject liquid toward a target medium. A light emitter is operable to emit light. A light receiver is adapted to receive the light emitted from the light emitter, and operable to output a signal in accordance with an amount of the received light, thereby detecting a position of the liquid ejecting head. A transparent member is disposed between the light emitter and the light receiver. A first line pattern is provided with the transparent member so as to oppose the light emitter, and includes first light transmitting sections and first light shielding sections which are alternately arranged in a first direction with a first pitch. A first actuator is operable to move either the light receiver or the transparent member in a second direction perpendicular to the first direction, thereby varying a distance between the transparent member and the light receiver.

### BACKGROUND

1. Technical Field

The present invention relates to a position detector and a liquid ejecting apparatus incorporating the same.

2. Related Art

In an ink jet printer, a carriage and a printed object such as paper are driven by a motor. Incidentally, in order to perform position control and speed control, an encoder is generally used. The encoder includes a photo sensor and a scale. The photo sensor includes a light emitting element and a light receiving element. the scale includes a light transmitting section which transmits light emitted from the light emitting element, and a light shielding section which shields light emitted from the light emitting element. These light transmitting section and light shielding section are repetitively arranged at a fixed pitch.

In such the encoder, recently, there is a problem of attachment of ink mist. Namely, recent printers which perform printing with high precision can eject minute ink droplets from a printing head. These minute ink droplets readily become ink mist and drift inside the printer. Therefore, as such the printer is used for a while, solidified ink mist is piled on the scale.

Japanese Patent Publication No. 2005-81691A (JP-A-2005-81691) teaches that a partition member is arranged between a carriage belt and a scale to prevent the attachment of the ink mist onto the scale. Japanese Patent Publication No. 2004-202963A (JP-A-2004-202963) discloses a configuration for correcting, in a case where duty factor of a signal outputted from a light receiving element decreases due to the attached ink mist, the duty factor of the output signal so as to become 50%.

In a case where the ink mist is attached onto the light transmitting section of the scale, light which passes through the light transmitting section is diffracted and causes a disadvantageous effect such as an erroneous detection. However, any means for preventing such the disadvantage is not disclosed in the above publications.

In addition, it is desired to recognize, in advance, when the erroneous detection occurs due to the attachment of the ink mist in view of the degree of dirt. However, any means for detecting the degree of dirt is not disclosed in the above publication.

### SUMMARY

It is an advantage of some aspects of the invention to provide a position detector which can detect the degree of dirt in a scale and enhance a detectability based on the detected dirt degree, and to provide a liquid ejecting apparatus incorporating such a position detector.

According to one aspect of the invention, there is provided a liquid ejecting apparatus, comprising:

a liquid ejecting head, operable to eject liquid toward a target medium;

a light emitter, operable to emit light;

a light receiver, adapted to receive the light emitted from the light emitter, and operable to output a signal in accordance with an amount of the received light, thereby detecting a position of the liquid ejecting head;

a transparent member, disposed between the light emitter and the light receiver;

a first line pattern, provided with the transparent member so as to oppose the light emitter, and including first light transmitting sections and first light shielding sections which are alternately arranged in a first direction with a first pitch; and

a first actuator, operable to move either the light receiver or the transparent member in a second direction perpendicular to the first direction, thereby varying a distance between the transparent member and the light receiver.

The liquid ejecting apparatus may further comprise a second line pattern, provided with the transparent member so as to oppose the light emitter, and including second light transmitting sections and second light shielding sections which are alternately arranged in the first direction with the first pitch. Each of the first light transmitting sections has a first transmittance and each of the second light transmitting sections has a second transmittance smaller than the first transmittance.

The first line pattern and the second line pattern may be adjacent to each other in the first direction.

The first line pattern and the second line pattern may be adjacent to each other in a third direction orthogonal to the first direction and the second direction.

The liquid ejecting apparatus may further comprise a second actuator, operable to move either the light receiver or the transparent member in the third direction.

According to one aspect of the invention, there is also provided a method of managing a detection accuracy of the above liquid ejecting apparatus, comprising:

driving the first actuator so as to increase the distance between the transparent member and the light receiver;

detecting a change in light receiving condition of the light receiver before or after the driving of the first actuator; and

judging a degree of dirt on the transparent member based on the detected change.

The method may further comprise driving the first actuator so as to decrease the distance between the transparent member and the light receiver than the original distance, in accordance with the judged degree of dirt.

The method may further comprise moving either the transparent member or the light receiver in a third direction orthogonal to the first direction and the second direction, in accordance with the judged degree of dirt.

### BRIEF DESCRIPTION OF THE DRAWINGS

FIG. 1 is a perspective view of a printer incorporating a position detector according to one embodiment of the invention.

FIG. 2 is a schematic view showing a motor driving control system in the printer.

FIG. 3 is a schematic section view showing a sheet transporting system in the printer.

FIG. 4 is a schematic view showing a linear encoder in the printer.

FIG. 5 is an enlarged plan view of a linear scale in the linear encoder.

FIG. 6 is a diagram showing a detailed configuration of the linear encoder.

FIG. 7 is a timing chart showing signals outputted from the linear encoder.

FIG. 8 is a schematic view showing a modified example of the linear encoder.

FIG. 9 is a perspective view showing a longitudinal end portion of a linear scale in the linear encoder, and viewed from an inner side of the printer.

FIG. 10 is a perspective view showing the longitudinal end portion of the linear scale in the linear encoder, and viewed from an outer side of the printer.

FIG. 11 is a schematic view showing a rotary encoder in the printer.

FIG. 12 is a flowchart showing a flow including a processing for detecting dirt of the linear scale.

FIG. 13 is a flowchart showing a detailed flow of the processing for detecting the dirt of the linear scale.

FIG. 14 is an enlarged schematic view showing a state that ink mist is attached on a dirt detection pattern of the linear scale.

### DESCRIPTION OF EXEMPLARY EMBODIMENTS

A position detector according to one embodiment of the invention and a printer 10 using this position detector will be described below with reference to the accompanying drawings. The printer 10 in the embodiment is an ink jet type printer. However, such the ink jet printer, as long as it can eject ink to perform printing, may adopt any ejection method.

In the following description, a “downside” indicates a side on which the printer 10 is placed, and an “upside” indicates a side apart from the side on which the printer 10 is placed. A direction where a carriage 31 described later moves is taken as a primary scanning direction, and a direction which is orthogonal to the primary scanning direction and where a printed object P is transported is taken as a secondary scanning direction.

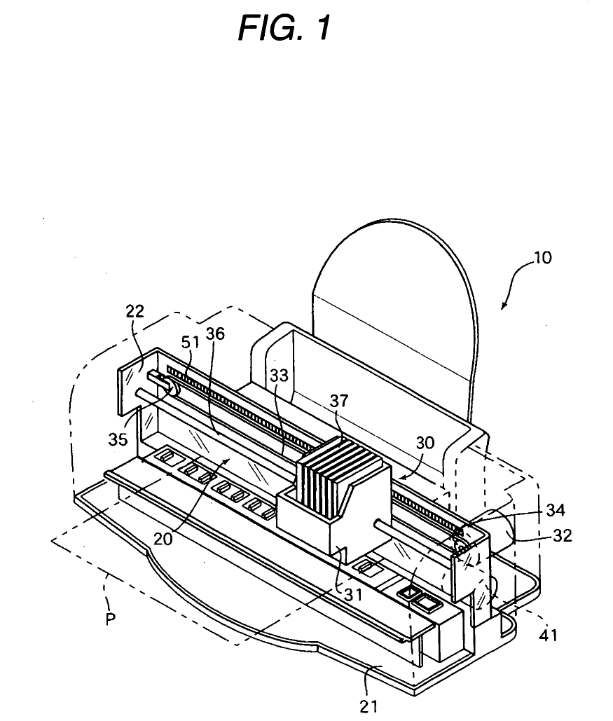

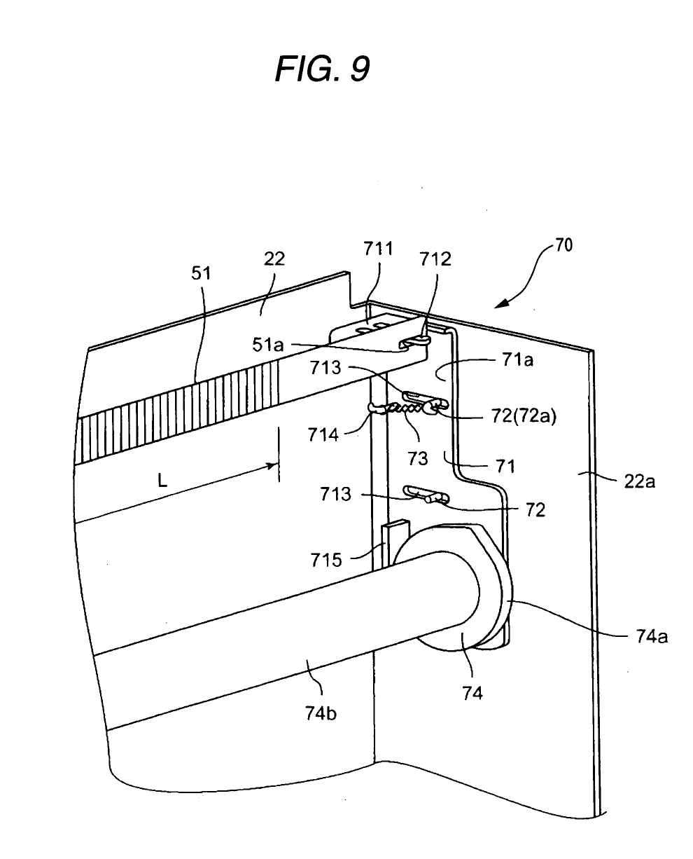

As shown in FIG. 1, the printer 10 comprises a housing 20, a carriage driving mechanism 30, a sheet transporting mechanism 40, a linear encoder 50, a scale moving mechanism 70 (see FIG. 9), a rotary encoder 80, and a controller 90.

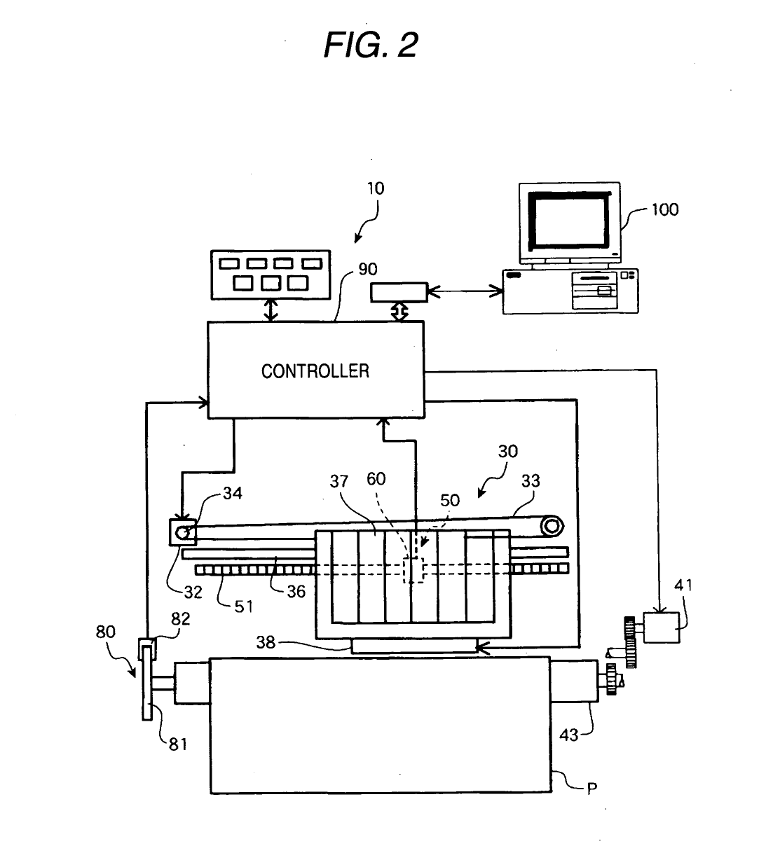

The housing 20 includes a chassis 21 placed on an installation surface, and a supporting frame 22 provide upright which extends from this chassis 21 upward. The carriage driving mechanism 30 includes a carriage 31, a carriage motor 32, a belt 33, a driving pulley 34, a follower pulley 35, and a carriage shaft 36. On the carriage 31, an ink cartridge 37 can be mounted. As shown in FIG. 2, on the lower face of the carriage 31, a printing head 38 which can eject ink droplets is provided. The belt 33 is an endless belt, and its part is fixed onto the rear face of the carriage 31. This belt 33 is stretched between the driving pulley 34 and the follower pulley 35.

The above printing head 38 is provided with not-shown nozzle arrays corresponding to each color of ink. In nozzles constituting this nozzle array, not-shown piezoelectric elements are arranged. By the operation of this piezoelectric element, the ink droplet can be ejected from the nozzle that is located at the end portion of an ink passage. The printing head 38 is not limited to the piezoelectric type using the piezoelectric element, but may adopt, for example, a heater type which heats ink and utilizes power of the produced bubbles, a magnetostrictive type which uses a magnetostrictive element, or a mist type which controls mist by an electric field. The ink filled into the cartridge 37 may be any kind of ink, for example, dye-based ink or pigment-based ink.

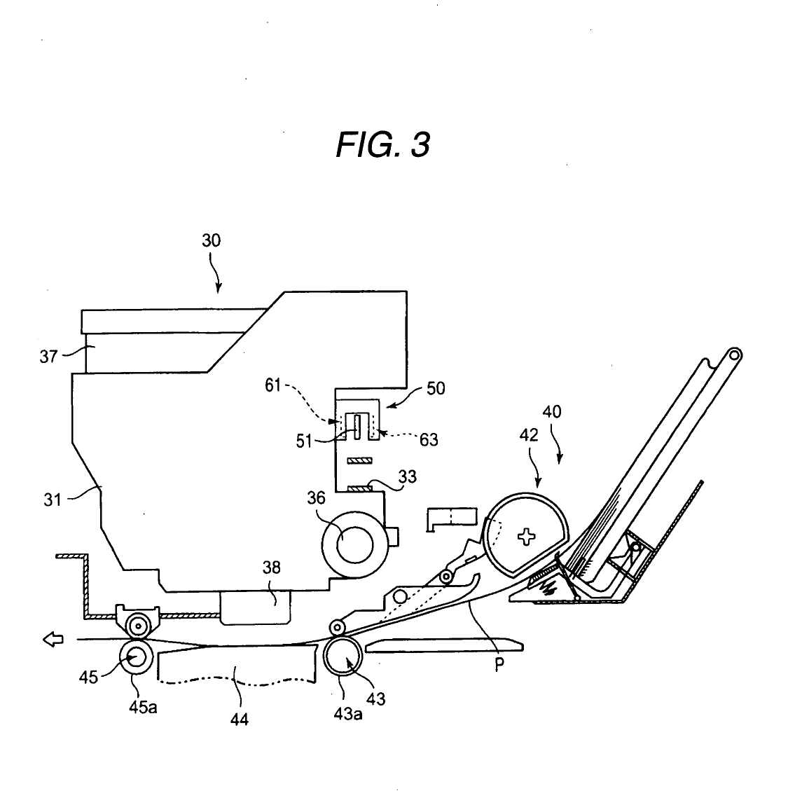

As shown in FIG. 3, the sheet transporting mechanism 40 includes a motor 41 and a sheet feeding roller 42 for feeding a printed object P such as plain paper (refer to FIG. 2). On the downstream side of the sheet feeding roller 42, a sheet transporting roller pair 43 for transporting the printed object P nipped therebetween is provided. On the downstream side of the sheet transporting roller pair 43, a platen 44 and the above-mentioned printing head 38 are provided so as to be opposed to each other in the vertical direction. The platen 44 supports, from the downside, the printed object P being transported below the printing head 38 by the sheet transporting roller pair 43. On the downstream side of the platen 44, a sheet ejecting roller pair 45 similar to the sheet transporting roller pair 43 is provided.

The driving force from the motor 41 is transmitted to a driving roller 43a in the sheet feeding roller pair 43 and a driving roller 45a in the sheet ejecting roller pair 45.

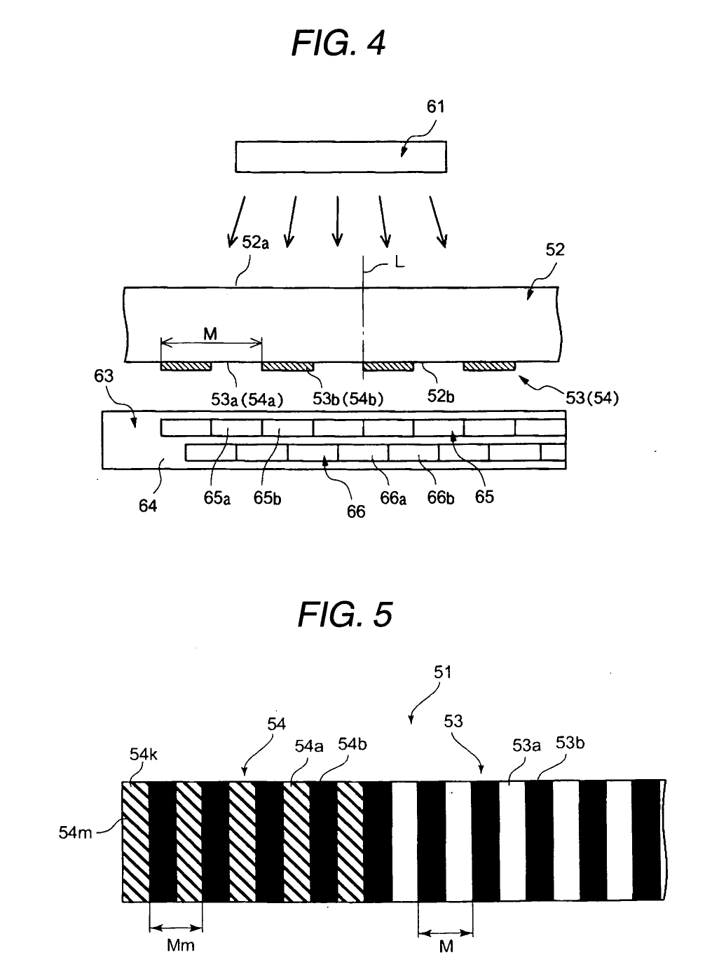

As shown in FIG. 4, the linear encoder 50 includes a linear scale 51 and a photo sensor 60. The linear scale 51 is formed of an elongated transparent member 52 made of a transparent material such as PET (polyethylene terephthalate). However, other various materials can be applied as the transparent member. As shown in FIG. 9, holes 51a are formed at both longitudinal ends of the linear scale 51, and hooks 712 (described later) are respectively inserted into the holes 51a, so that the linear scale 51 is suspended between the hooks 712.

For convenience of description, of the transparent member 52, a surface facing a light emitter 61 (described later) will be described below as a front surface 52a, and a surface facing a light receiver 63 (described later) will be described as a back surface 52b.

As shown in FIG. 5, position detecting patterns 53 and dirt detecting patterns 54 are formed on the linear scale 51. The position detecting patterns 53 include first light transmitting sections 53a transmitting light and first light shielding sections 53b shielding light. The first light shielding sections 53b are sections formed by performing a black print with such a thickness not to transmit light on the front surface of the transparent member 52. The first light transmitting sections 53a are portions to which the black print is not performed and can transmit light emitted from the light emitters 61 to be described later.

In the embodiment, the dirt detecting patterns 54 are not necessarily required and a configuration from which the dirt detecting patterns 54 are omitted may be employed.

Here, in the embodiment, the first light transmitting sections 53a and the first light shielding sections 53b have the same width, that is, the same pitch. The widths of the first light transmitting sections 53a and the first light shielding sections 53b are not necessarily equal to each other, but the pitch with which the first light transmitting sections 53a and the first light shielding sections 53b are alternately disposed (hereinafter, referred to as a mask pitch M) must be constant all over the circumference.

The dirt detecting patterns 54 are provided in a position closer to the longitudinal end of the linear scale 51 than a portion that the position detecting patterns 53 are provided. The position is outer than one end of a printing region. Similarly to the position detecting patterns 53, the dirt detecting patterns 54 include second light transmitting sections 54a transmitting light and second light shielding sections 54b shielding light.

Here, the second light transmitting sections 54a of the dirt detecting patterns 54 have a light transmitting area and a light transmittance which are smaller than those of the first light transmitting sections 53a of the position detecting patterns 53. In order to decrease the light transmittance of the light transmitting sections 53a, a light shielding pattern 54k may be provided in the second light transmitting sections 54a. Here, the light shielding pattern 54k includes a plurality of hatched light shielding sections 54m which are tilted about the tangential direction of the rotary scale 51. The light transmitting area and the light transmittance of the second light transmitting sections 54a are smaller than the light transmitting area and the light transmittance of the first light transmitting sections 53a due to existence of the light shielding sections 54m. The light intensity of the light passing through the second light transmitting sections 54a is smaller than the light intensity of the light passing through the first light transmitting sections 53a.

The mask pitch Mm formed by the second light transmitting sections 54a and the second light shielding sections 54b is equal to the mask pitch M formed by the first light transmitting sections 53a and the first light shielding sections 53b. However, the mask pitch Mm may be different from the mask pitch M. The dirt detecting patterns 54 are not limited to the structure in which they are disposed on the end of the linear scale 51 in the longitudinal direction (i.e., the position detecting patterns 53 and the dirt detecting patterns 54 are horizontally arranged). For example, the position detecting patterns 53 and the dirt detecting patterns 54 may be vertically arranged.

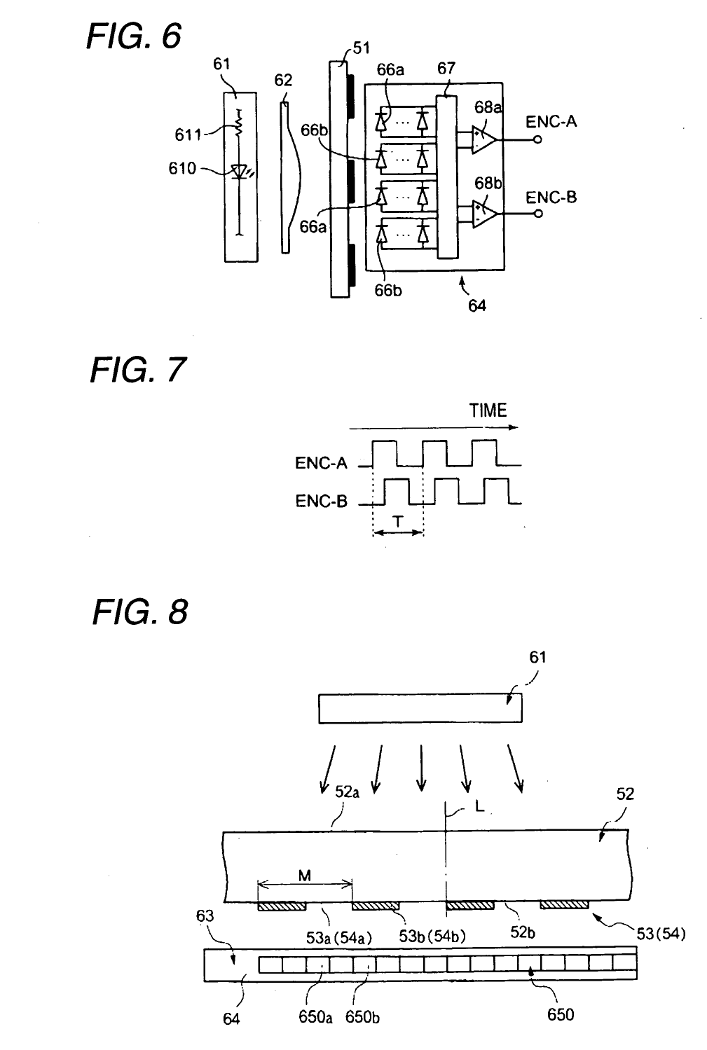

As shown in FIGS. 4 and 6, the photo sensor 60 comprises a light emitter 61, a collimator lens 62, and a light receiver 63. These light emitter 61 and light receiver 63 are opposed to each other through the linear scale 51 located between the collimator lens 62 and the light receiver 63 in a non-contact manner. The light emitter 61 comprises light emitting element 610 such as a light emitting diode, and the light generated by this light emitting element 610 is emitted toward the linear scale 51.

The light receiver 63 comprises a substrate 64, and a first light receiving element array 65 and a second light receiving element array 66 which are provided on this substrate 64. In the first light receiving element array 65, plural light receiving elements 65a and 65b are arrayed. Similarly, in the second light receiving element array 66, plural light receiving elements 66a and 66b are arrayed. Each of the light receiving elements 65a, 65b, 66a, and 66b can convert the received light into an electric signal according to the quantity of the received light. A phototransistor, a photodiode, a photo-IC or the like may be adopted as the light receiving element. These light receiving elements are arranged such that two elements are provided in every one segment (corresponding to the mask pitch M) constituted by a pair of the light transmitting section 53a (54a) and 53b (54b). Further, the first light receiving element array 65 and the second light receiving element array 66 are shifted from each other in the extending direction thereof by one fourth of the mask pitch M so that a phase difference between the arrays 65 and 66 becomes 90 degrees.

In a case where the width dimension of the light transmitting section 53a, 54a is the same as that of the light shielding section 53b, 54b as in this embodiment, one light receiving element is associated with each of the light emitting sections 53a (54a) and the light shielding sections 53b (54b).

As shown in FIG. 6, the plural light receiving elements 65a, 65b, 66a, 66b are connected to a signal amplifier 67. Analog waveform signals outputted from the light receiving elements, after being amplified by this signal amplifier 67, are outputted to a first comparator 68a and a second comparator 68b. The first comparator 68a and the second comparator 68b output pulse waveform digital signals on the basis of the analog signals outputted through the signal amplifier 67 from the respective light receiving element arrays 65 and 66.

Here, the light receiving element 65a in the first light receiving element array 65 is connected to a positive terminal of the first comparator 68a, and the light receiving element 65b in the first light receiving element array 65 is connected to a negative terminal of the first comparator 68a. The light receiving elements 66a and 66b in the second light receiving array 66 are similarly connected to the second comparator 68b. For example, in a case where the level of the analog signal inputted to the positive terminal is higher than the level of the analog signal inputted to the negative terminal, a high-level signal is outputted. In the contrary case, a low-level signal is outputted. Hereby, it is possible to output pulse signals (ENC-A, ENC-B) as shown in FIG. 7, corresponding to detection by the light transmitting section 53a, 54a and the light shielding section 53b, 54b.

A pulse signal ENC-A is outputted from the first comparator 68a corresponding to the first light receiving element array 65, and a pulse signal ENC-B in which the phase is shifted by 90 degrees is outputted from the second comparator 68b corresponding to the second light receiving element array 66 shifted by one fourth of the mask pitch M relative to the first light receiving element array 65.

Here, as shown in FIG. 8, there may be adopted a configuration in which a single light receiving element array 650 is provided. In this case, a light receiving element 650a is connected to either a positive terminal or a negative terminal of the first comparator 68a, and a light receiving element 650b is connected to either a positive terminal or a negative terminal of the second comparator 68b.

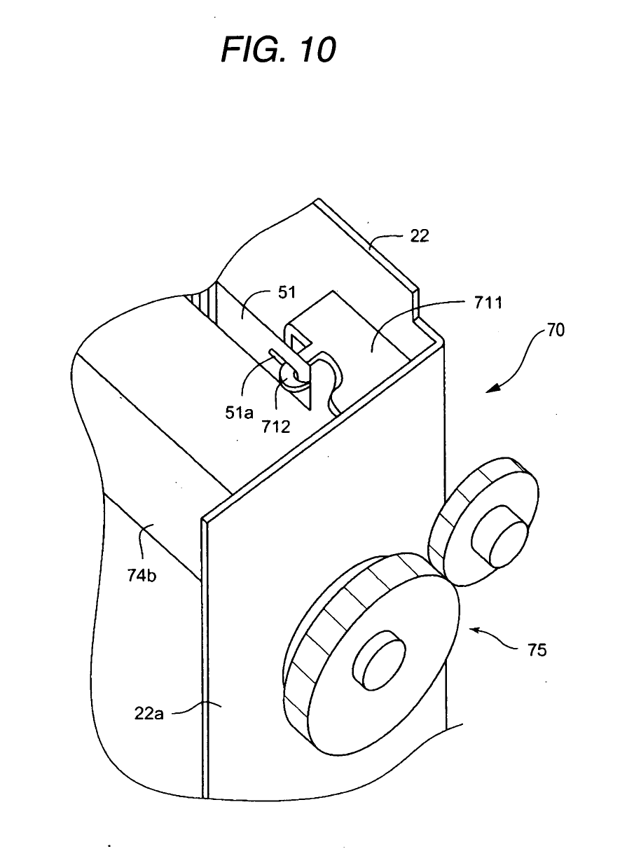

Next, the scale moving mechanism 70 will be described with reference to FIGS. 9 and 10. As shown in FIG. 9, the scale moving mechanism 70 includes a supporting plate 71, a guide pin 72, a spring 73, an eccentric cam 74, and a gear train 75.

The supporting plate 71 is formed by a bending process. A bent portion 711 is extended from an upper end of a base portion 71a. A hook 712 is provided at a portion of the bent portion 711 away by a predetermined distance from the base portion 71a. A tip end of the hook 712 bent toward the base portion 71a from a joint of the hook 712. The hook 712 engages with the hole 51a of the linear scale 51. The linear scale 51 can be supported in a suspended state by the engagement.

A pair of guide slots 713 are formed in the base portion 71a. The guide pins 72 are inserted into the guide slots 713. The guide pins 72 are members protruding from a side face 22a of the support frame 22. By inserting the guide pins 72 into the guide slots 713, the supporting plate 71 can slide in the sheet transporting direction (as represented by an arrow in FIG. 3).

Here, the end of one guide pin 72a of the guide pins 72 has a hook shape protruding toward the sheet ejecting direction from the joint of the guide pin 72a. One end of the spring 73 is hooked and fixed to the guide pin 72a. The hook-shaped guide pin 72a is also referred to as a spring engagement pin 72a in the following description.

A spring engagement member 714 is projected from the base portion 71a at a position in the sheet supply side of the guide slot 713 so as to correspond to the spring engagement pin 72a. The other end of the spring 73 is hooked and fixed to the spring engagement member 714 so that the spring 73 is suspended between the spring engagement pin 72a and the spring engagement member 714. Accordingly, an elastic bias force directed to the sheet ejecting side is given to the supporting plate 71.

A bracket 715 is projected from the base portion 71a so as to extend in the vertical direction. A cam face 74a of the eccentric cam 74 comes in contact with the bracket 715. Here, the bracket 715 always comes in contact with the cam face 74a by the elastic bias force of the spring 73. Accordingly, when the eccentric cam 74 rotates, the supporting plate 71 can slide in the sheet transporting direction along the shape of the cam face 74a and the shape of the guide slot 713. The eccentric cam 74 is disposed on a rotary shaft 74b. The read end gear of the great train 75 is provided on the rotary shaft 74b.

Here, the motor for rotating the eccentric cam 74 may be a motor independent of the motors 32 and 41 described above and may employ a configuration for distributing the driving force of the motor 41. In such a configuration, it is necessary to employ a configuration that the eccentric cam 74 does not rotate at the time of carrying the printed object P using a mechanism for switching engagement and disengagement of some gears of the gear train 75.

Only one side end of the printer 10 is shown in FIGS. 9 and 10. However, the above-mentioned configuration is provided at the opposite side end of the printer 10 and the linear scale 51 can move uniformly in the sheet transporting direction.

As shown in FIG. 11, the rotary encoder 80 comprises a disc-shaped scale 81 rotated by the motor 41, and a photo sensor 82 similar to the photo sensor 60 of the linear encoder 50. This rotary encoder 80 has the same constitution as that of the linear encoder 50 except that the scale 81 is formed in the shape of a disc. Therefore, the detailed description of the rotary encoder 80 is omitted.

As shown in FIG. 2, an encoder signal outputted from the linear encoder 50 or the rotary encoder 80, a print signal from a computer 100, and various output signals are inputted to a controller 90. More specifically, the controller 90 includes CPU, ROM, RAM, ASIC, a DC unit, and a driver to control the carriage motor 32, the printing head 38, the motor 41, and the like.

When the printer 10 is operated under the above constitution, the operation performed by the linear encoder 50 will be described below.

When the linear encoder 50 is activated and the light emitter 61 emits the light toward the linear scale 51, the emitted light passes through the collimator lens 62, so that the light emergent from the collimator lens 62 becomes parallel light. A part of the emergent light to be incident on the light receiving elements 65a to 66b located on the longitudinal end portions of the light receiving element arrays 65, 66 travels in the transparent member 52 without being reflected by the front surface 52a. The light emitted from the back surface 52b of the transparent member 52 reaches the first light transmitting sections 53a or the first light shielding sections 53b.

Here, when minute ink droplets are ejected from the printing head 38 to the printed object P, the ink mist floats inside the printer 10 and is accumulatively attached as dirt to the linear scale 51. In this case, in the printer 10, the dirt of the linear scale 51 is detected at predetermined timings. Hereinafter, a series of operations of the printer 10 at the time of detecting the dirt of the linear scale 51 will be described.

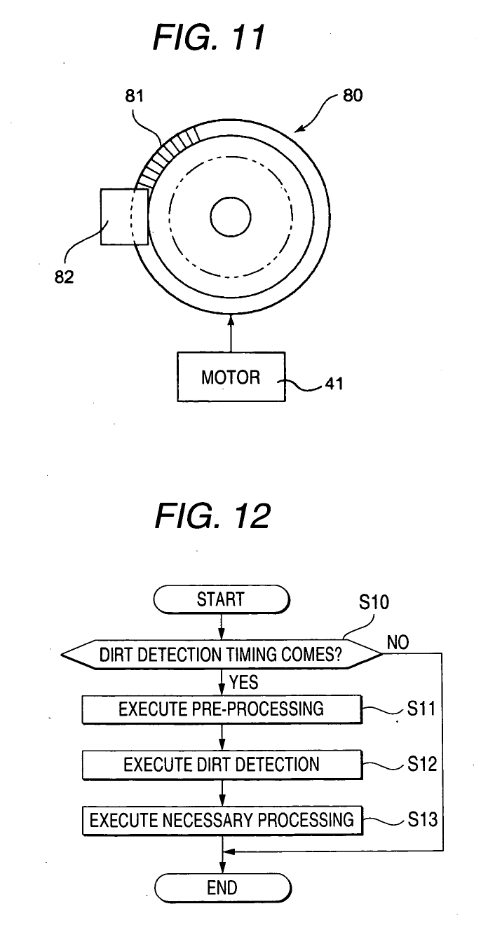

As shown in FIG. 12, first, the controller 90 judges whether it is the timing to detect the dirt of the linear scale 51 (S10). The timing to detect the dirt of the linear scale 51 may be a timing, for example, after the printing work is completely performed to a print sheet or predetermined number of print sheets P, or when the printer 10 is activated. The timing to detect the dirt of the linear scale 51 may be a timing when a predetermined time period t1 has been passed since the printer 10 is activated, or whenever a predetermined time period t2 has been passed thereafter. The timing to detect the dirt of the linear scale 51 may be a timing when the printing work is completely performed to a predetermined number n1 of printed objects P after the printer is activated, or whenever the printing work is completely performed to a predetermined number n2 of printed objects P thereafter.

When it is judged in step S10 that it is not the timing for detection (NO in S10), the dirt of the linear scale 51 is not detected, but the printer 10 is in a standby state or performs the printing work to the next printed object P. On the other hand, when it is judged in step S10 that it is the timing for detection (YES in S10), a predetermined pre-processing is performed (S11). Here, the pre-processing means a processing of driving the carriage motor 32 to move the carriage 31 to a position (for example, a home position) suitable for detecting the dirt and an activation of the scale moving mechanism 70 to be described later, but processes other than the above-mentioned processes may be included in the pre-processing.

Here, the pre-processing may include an operation of activating the scale moving mechanism 70. In this case, the scale moving mechanism 70 moves the linear scale 51 to approach the light emitter 61. Then, the linear scale 51 is spaced apart from the light receiver 63. Here, when the ink mist is attached to the first light transmitting sections 53a, the light passing through the first light transmitting sections 53a is often diffracted due to the ink mist. The effect of the diffraction becomes stronger as the distance between the first light transmitting section 53a and the light receiver 63 increases. Accordingly, when the linear scale 51 comes away from the light receiver 63, the light is diffracted and the light is incident on the light receiving elements 65a to 66b which are originally covered with the light shielding sections 53b and 54b to block the incidence of light thereto. Accordingly, the detection precision of the light emitted from the light emitter 61 is deteriorated. As a result, when the first light transmitting sections 53a come away from the light receiver 63, it is possible to find out the detection limit of the first light transmitting sections 53a in advance. It is also possible to sense the detection lifetime on the basis of the distance by which the linear scale 51 comes away from the light receiver 63.

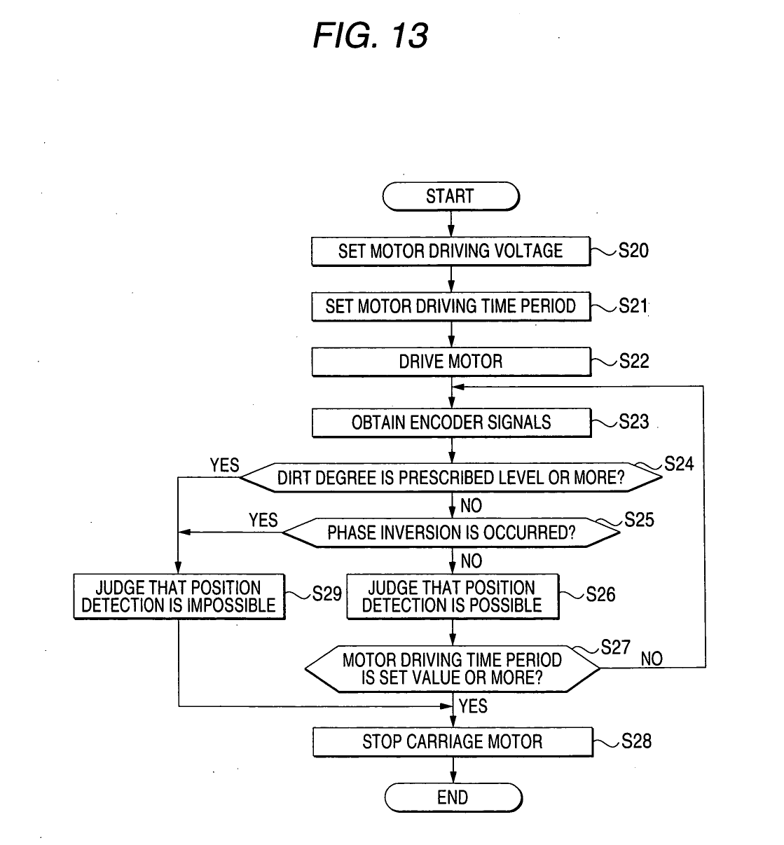

After the pre-processings are completed, the degree of dirt of the linear scale 51 (position detecting patterns 53) is detected (S12) while moving the carriage 31 in the primary scanning direction by driving the carriage motor 32. The detection is performed on the basis of the process flow shown in FIG. 13.

When the detection is completed in step S12, a necessary processing is performed (S13) in accordance with the detected degree of dirt of the linear scale 51. In step S13, a variety of processes can be considered and the processes will be described below.

An example of such processes can include a processing of activating the scale moving mechanism 70 to bring the linear scale 51 close to the light receiver 63. In this case, it is possible to reduce the effect of diffraction due to the attachment of the ink mist to the first light transmitting sections 53a and thus to decrease the possibility of the erroneous detection. Since this process is finished only with movement of the linear scale 51 and does not accompany increase in power consumption, it is simple and economical.

Another example of such processes can include a processing of setting the driving voltage of the carriage motor 32. More specifically, the driving voltage is set so that the movement speed of the photo sensor 60 is slower than that when the ink mist is not attached. In this case, when a predetermined amount of ink mist is attached to the linear scale 51 and thus there is possibility of the erroneous detection in the linear encoder 50, it is possible to reduce the possibility of the erroneous detection.

Another example of such processes can include a processing of checking whether the detection limit of the linear scale 51 can be reached by performing the printing work to which number of printed objects P. More specifically, the number of print sheets or the print time until the linear scale 51 reaches the detection limit is calculated by the controller 90. By performing the check and calculation, it is possible to be aware of the number of print sheets or the print time until the linear scale 51 is contaminated.

Another example of such processes can -include a processing of displaying a predetermined message on a display device (not shown) such as a liquid crystal display provided in the printer 10. The predetermined message includes a notice indicating that the linear scale 51 comes close the detection limit or almost reaches the detection limit, an error message resulting from the dirt of the linear scale 51, and a message indicating that it is necessary to clean the linear scale 51. It is possible to inform a user that the linear scale 51 is contaminated by displaying the messages and to prevent operation failure of the printer 10 due to the erroneous detection of the linear scale 51.

Another example of such processes can include a processing of stopping the operation of the printer so as not to use the printer when the degree of dirt is great. By not allowing the use of the printer 10, it is possible to prevent the operation failure of the printer 10 due to the erroneous detection of the linear scale 51 and to prevent damage or the like on the printer 10 due to the transporting failure of the printed object. Another example can include a processing of allowing the controller 90 to control the printer so that the printer 10 is stopped after the printing work is performed for a predetermined time period or to a predetermined number of sheets after detecting the dirt.

Another example can include a processing of setting the upper limit of the rotation speed of the carriage motor 32 to regulate the rotation speed of the linear scale 51. In this case, the rotation speed of the linear scale 51 is lowered and thus it is possible to prevent the erroneous detection of the photo sensor 60 even when the linear scale 51 is contaminated to some extent. By preventing such erroneous detection, it is possible to allow the printer 10 to perform a print work to a predetermined number of sheets or for a predetermined time.

Another example can include a processing of perform the control for increasing the amount of light emitted from the light emitting element 610 by providing a variable resistor 611 in the light emitter 61 (see FIG. 6) and adjusting the variable resistor 611. When the linear scale 51 is contaminated more or less but the degree of dirt is not great, the printer 10 can perform the printing work in a predetermined number of sheets or for a predetermined time period by increasing the amount of light emitted from the light emitting element 610. The amount of light emitted from the light emitting element 610 may be increased gradually by the use of the variable resistor 611 with such an increasing rate to perform the printing work in a predetermined number of sheets or for a predetermined time period. In this case, it is possible to reduce the power consumption of the light emitter 61.

Another example can include a processing of deviating the detection position in the position detecting patterns 53 by activating a scale lifting mechanism in a case where the printer 10 is provided with such a mechanism. For example, since the ink mist can be easily attached to the lower portions of the position detecting patterns 53 and thus the detection precision can be easily deteriorated, the scale lifting mechanism may be activated to detect the upper portion of the linear scale 51.

Another example can include a processing of removing the dirt of the linear scale 51 by wiping with a cleaning member such as a sponge.

Next, the processing for detecting the degree of dirt of the linear scale 51 (position detecting patterns 53) in S12 will be described with reference to FIG. 13. In the process flow shown in FIG. 13, the degree of dirt is detected all over the longitudinal direction of the linear scale 51 while the photo sensor 60 moves along the linear scale 51 by driving the carriage motor 32. However, the degree of dirt of the linear scale 51 may be detected only by operating the scale moving mechanism 70 without driving the carriage motor 32. In this case, the degree of dirt is detected by only a part of the linear scale 51.

First, as shown in FIG. 13, a driving voltage of the carriage motor 32 is set (S20). More specifically, in response to a command from the controller 90, a driving voltage corresponding to a rotation speed for the dirt detection is applied to the carriage motor 32. Subsequently, a driving time period of the carriage motor 32 is set (S21).

Next, the carriage motor 32 is driven with the set driving voltage for the set driving time period (S22). The carriage 31 moves with the driving of the carriage motor 32 and the photo sensor 60 fixed to the carriage 31 moves relative to the linear scale 51. With the relative movement, the linear encoder 50 outputs, for example, an A-phase signal ENC-A and a B-phase signal ENC-B with a cycle T The A-phase signal ENC-A and the B-phase signal ENC-B which are the output signals of the linear encoder 50 are input to the controller 90. That is, the controller 90 acquires the output signals of the linear encoder 50 (S23).

Thereafter, the controller 90 judges whether the degree of dirt of the linear scale 51 is greater than a predetermined value (S24). This judgment may be performed by comparing the pulse signals ENC-A and ENC-B with each other in a state in which the light receiver 63 is normal. The judgment on whether the degree of dirt is greater than a predetermined value may be performed using the dirt detecting patterns 54 provided in the linear scale 51. By bringing the linear scale 51 away from the dirt detecting patterns 54, this is because it can be earlier judged for the dirt detecting patterns 54 in the state in which the detection precision of the light receiver 63 is deteriorated whether the degree of dirt is greater than a predetermined degree.

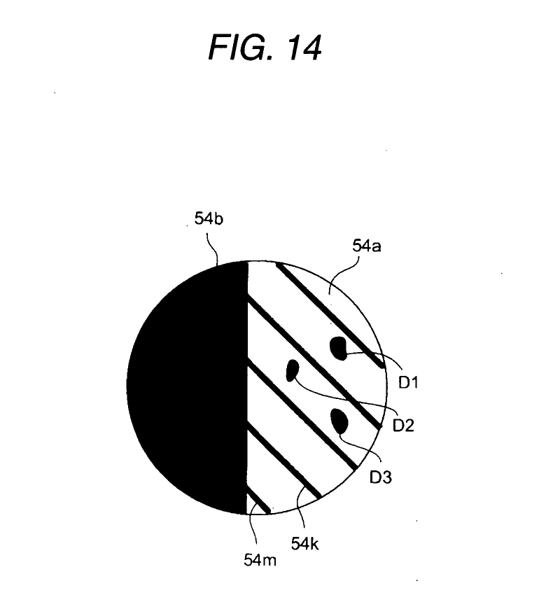

When a predetermined amount of ink mist is accumulated on the linear scale 51 and the accumulated ink mist grows to a predetermined size, for example, as shown in FIG. 14, stains D1, D2, and D3 are made by the ink mist is attached in the second light transmitting section 54a. The light passing through the second light transmitting section 54a is blocked by the stains D1 and D2 and the light shielding section 54m. When the stains (portions shielding the light) are generated, the period of the A-phase signal. ENC-A or the B-phase signal ENC-B output from the linear encoder 50 is varied. In the embodiment, when a predetermined variation occurs in the cycle of the A-phase signal ENC-A or the B-phase signal ENC-B output from the linear encoder 50, it is judged that the stains (portions shielding the light) are generated in the dirt detecting patterns 54. In this state, it is judged that a degree of dirt greater than a predetermined degree occurs in the linear scale 51.

More specifically, in step S24, it is judged whether the cycle (or the frequency) of the A-phase signal ENC-A or the B-phase signal ENC-B when the photo sensor 60 passes through the dirt detecting patterns 54 deviates from the range of ±×% (for example, ±15%) of the basic cycle T (or frequency). When it is judges that it does not deviate from the range of ±×% (NO), it is subsequently judged whether the phases of the A-phase signal ENC-A and the B-phase signal ENC-B are inverted (S25).

When NO is judged in S25, the detected period does not deviate from the range of ±×% and the inversion of the phase does not occur. Accordingly, it is judged that the accurate position detection in the linear encoder 50 is possible (that is, the accurate detection is possible) with the dirt detecting patterns 54 (step S26). That is, since a sufficient size or amount of stains (portions shielding light) are not formed in the second light transmitting sections 54a, it is judged that the degree of dirt is within the allowable range and thus the position detection in the linear encoder 50 is possible.

Subsequently, it is judged whether the driving time period of the carriage motor 32 is greater than the set time (step S27). When it is judged that the driving time period of the carriage motor 32 is less than the set time, the judgment and process subsequent to S23 is performed again in S23. When the driving time period of the carriage motor 32 is greater than the set time period, the carriage motor 32 is stopped (step S28). By activating the scale moving mechanism 70 after stopping the carriage motor 32, the linear scale 51 is restored to the original position. With the movement, the linear scale 51 is in the state in which general position detection is possible.

In this way, the detection of dirt is completed and then the position detection of the linear encoder 50 becomes possible.

In S24, when the period T1 of the A-phase signal ENC-A or the B-phase signal ENC-B deviates from the range of ±×% from the cycle T (YES) or when the phases of the A-phase signal ENC-A and the B-phase signal ENC-B are inverted (YES), it is judged that a sufficient size or amount of stains (portions shielding light) are formed in the second light transmitting section 54a and thus the corresponding processes are performed. That is, it is judged that the accurate position detection with the linear encoder 50 is not possible (S29). In this case, the carriage motor 32 is stopped in S28.

According to the printer 10 having the above-mentioned configuration, the linear scale 51 can move between the light emitter 61 and the light receiver 63 by the scale moving mechanism 70. Accordingly, the linear scale 51 can come close to and away from the light emitter 61 and the light receiver 63.

On the contrary to the above-described case, when the linear scale 51 moves to come close to the light receiver 63, it is possible to enhance the detection precision of the light receiver 63. That is, even when the ink mist is attached to the linear scale 51 and the light is diffracted by the portions to which the ink mist is attached, the linear scale 51 is not much affected by the diffraction by coming close to the light receiver 63. Accordingly, even when a predetermined amount of ink mist is attached thereto, it is possible to maintain the detection precision of the light receiver 63, thereby elongating the detection lifetime of the linear scale 51.

A driving force for sliding is given to the supporting plate 71 from the motor through the eccentric cam 74 and the gear train 75. Specifically, in the embodiment, the eccentric cam 74 is provided and thus by converting the driving force of the motor into the rotary motion of the eccentric cam 74, it is possible to allow the supporting plate 71 to smoothly slide. Accordingly, the linear scale 51 can be brought close to the light emitter 61 or the light receiver 63, thereby easily accomplishing the detection of the degree of dirt and the elongation of the lifetime of the linear scale 51.

In the embodiment, the position detecting patterns 53 and the dirt detecting patterns 54 are provided in the linear scale 51. Accordingly, it is possible to detect the degree of dirt in the linear scale 51 using the dirt detecting patterns 54, as well as to detect the dirt with the movement of the linear scale 51 using the scale moving mechanism 70. As a result, it is possible to further accurately judge the degree of dirt in the linear scale 51. When it is judged from the detection result that the degree of dirt greater than a predetermined degree is generated in the linear scale 51, the linear scale 51 comes close to the light receiver 63 under the controlling of the motor by the controller 90. Even when the light is diffracted by the portions of the linear scale 51 to which the ink mist is attached, the linear scale 51 is not much affected by the diffraction by coming close to the light receiver 63 and thus it is possible to enhance the detection precision of the light receiver 63. In addition, it is possible to elongate the detection lifetime of the linear scale 51.

In this embodiment, the scale moving mechanism 70 for moving the linear scale 51 is provided. However, instead of the scale moving mechanism 70, there may be provided a sensor moving mechanism for moving the photo sensor 60 in the sheet transporting direction. Even in such a configuration, the distance of the linear scale 51 relative to the light emitter 61 or the light receiver 63 can be varied. Accordingly, the same advantages can be obtained.

In this embodiment, the supporting plate 71 can slide in the sheet transporting direction with the rotation of the eccentric cam 74. However, the supporting plate 71 may be allowed to slide using an additional structure without providing the eccentric cam 74. For example, a rack gear is fitted to the lower side of the supporting plate 71 and a pinion gear is provided at the final stage of the gear train 75. Here, when the pinion gear is disposed at a fixed portion, the linear scale 51 can move to come close to and away from the light emitter 61 and the light receiver 63.

In this embodiment, the linear encoder 50 is used as the position detector. However, the same advantages can be obtained by applying the same concept with respect to the rotary encoder 80.

In the above embodiment, the printer 10 is exemplified as the liquid ejecting apparatus. However, the liquid ejecting apparatus may be any apparatus such as a color filter manufacturing apparatus, a dyeing machine, a micromachine, a semiconductor processing machine, a surface processing machine, a three-dimensional molding machine, a liquid vaporizing apparatus, an organic EL manufacturing apparatus (particularly, polymer EL manufacturing apparatus), a display manufacturing apparatus, a film coating system, and a DNA chip manufacturing apparatus. Here, liquid ejected from the apparatus is changed according to its purpose. For example, metal material, organic material, magnetic material, conductive material, wiring material, film coating material, and various processing liquid may be adopted.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2005-295967 filed Oct. 11, 2006 including specification, drawings and claims is incorporated herein by reference in its entirety.

What is claimed is:

1. A liquid ejecting apparatus, comprising:
a liquid ejecting head, operable to eject liquid toward a target medium;
a light emitter, operable to emit light;
a light receiver, adapted to receive the light emitted from the light emitter, and operable to output a signal in accordance with an amount of the received light, thereby detecting a position of the liquid ejecting head;
a transparent member, disposed between the light emitter and the light receiver;
a first line pattern, provided with the transparent member so as to oppose the light emitter, and including first light transmitting sections and first light shielding sections which are alternately arranged in a first direction with a first pitch; and
a first actuator, operable to move either the light receiver or the transparent member in a second direction perpendicular to the first direction, thereby varying a distance between the transparent member and the light receiver.

2. The liquid ejecting apparatus as set forth in claim 1, further comprising:
a second line pattern, provided with the transparent member so as to oppose the light emitter, and including second light transmitting sections and second light shielding sections which are alternately arranged in the first direction with the first pitch, wherein:
each of the first light transmitting sections has a first transmittance and each of the second light transmitting sections has a second transmittance smaller than the first transmittance.

3. The liquid ejecting apparatus as set forth in claim 2, wherein:
the first line pattern and the second line pattern are adjacent to each other in the first direction.

4. The liquid ejecting apparatus as set forth in claim 2, wherein:
the first line pattern and the second line pattern are adjacent to each other in a third direction orthogonal to the first direction and the second direction.

5. The liquid ejecting apparatus as set forth in claim 4, further comprising:
a second actuator, operable to move either the light receiver or the transparent member in the third direction.

6. The liquid ejecting apparatus as set forth in claim 1, further comprising:
a second actuator, operable to move either the light receiver or the transparent member in a third direction orthogonal to the first direction and the second direction.

7. A method of managing a detection accuracy of the liquid ejecting apparatus as set forth in claim 1, comprising:
driving the first actuator so as to increase the distance between the transparent member and the light receiver;
detecting a change in light receiving condition of the light receiver before or after the driving of the first actuator; and
judging a degree of dirt on the transparent member based on the detected change.

8. The method as set forth in claim 7, further comprising:
driving the first actuator so as to decrease the distance between the transparent member and the light receiver than the original distance, in accordance with the judged degree of dirt.

9. The method as set forth in claim 7, further comprising:
moving either the transparent member or the light receiver in a third direction orthogonal to the first direction and the second direction, in accordance with the judged degree of dirt.
